(19) United States
(12) Patent Application Publication
(10) Pub. No.: US 2026/0155591 A1
(43) Pub. Date: Jun. 4, 2026

(54) CONNECTOR TERMINAL, CONNECTOR AND CONNECTOR ASSEMBLY

(71) Applicant: Tyco Electronics (Shanghai) Co., Ltd., Shanghai (CN)

(72) Inventors: YuQiang (Thomas) Zhao, Shanghai (CN); Qianjin (Orando) Li, Shanghai (CN)

(73) Assignee: Tyco Electronics (Shanghai) Co., Ltd., Shanghai (CN)

(21) Appl. No.: 19/401,619

(22) Filed: Nov. 26, 2025

(30) Foreign Application Priority Data
Nov. 29, 2024 (CN) 202411752427.7

(51) Int. Cl. H01R 12/58; H01R 13/428

(52) U.S. Cl. CPC H01R 12/585; H01R 13/428

(57) ABSTRACT

A connector terminal includes a first terminal and a second terminal. The first terminal includes a first body in a form of a sheet and a first pin. The first body has an upper side and a lower side, and a front side and a rear side. The first pin is connected to the lower side of the first body. The second terminal includes a second body in a form of a sheet and a second pin. The second body has an upper side and a lower side, and a front side and a rear side. The second pin is connected to the lower side of the second body. The first body and the second body are stacked and fixed together. The first pin is combined with the second pin for simultaneous insertion into a socket formed in a circuit board.

### CROSS-REFERENCE TO RELATED APPLICATION

This application claims the benefit of the filing date under 35 U.S.C. § 119(a)-(d) of Chinese Patent Application No. CN202411752427.7 filed on Nov. 29, 2024, the whole disclosure of which is incorporated herein by reference.

### FIELD OF THE INVENTION

The present invention relates to a connector terminal and, more particularly, to a connector terminal, a connector comprising the connector terminal, and a connector assembly comprising the connector.

### BACKGROUND OF THE INVENTION

A connector typically includes a housing and multiple sheet-like terminals arranged within the housing. Each terminal has a pin for insertion into a socket in a circuit board. This will result in an excessive number of sockets in the circuit board, reducing the current carrying capacity per unit area of the circuit board, that is, lowering the current density of the circuit board. Therefore, when it is necessary to improve the current carrying capacity of connectors, it is necessary to increase the area of the circuit board. However, in some space limited applications, the area of the circuit board cannot be increased, which makes it difficult for existing connectors to be applied in these space limited situations, severely limiting the application range of connectors.

### SUMMARY OF THE INVENTION

A connector terminal includes a first terminal and a second terminal. The first terminal includes a first body in a form of a sheet and a first pin. The first body has an upper side and a lower side, and a front side and a rear side. The first pin is connected to the lower side of the first body. The second terminal includes a second body in a form of a sheet and a second pin. The second body has an upper side and a lower side, and a front side and a rear side. The second pin is connected to the lower side of the second body. The first body and the second body are stacked and fixed together. The first pin is combined with the second pin for simultaneous insertion into a socket formed in a circuit board.

### BRIEF DESCRIPTION OF DRAWINGS

The invention will now be described by way of example with reference to the accompanying figures, of which:

FIG. 1 is a perspective view of a connector terminal according to an exemplary embodiment;

FIG. 2 is an exploded view of the connector terminal of FIG. 1;

FIG. 3 is a bottom perspective view of the connector terminal of FIG. 1;

FIG. 4 is an illustrative view of the connector terminal of FIG. 1 and a circuit board according to an exemplary embodiment;

FIG. 5 is a perspective view of a connector according to an exemplary embodiment;

FIG. 6 is a partial exploded view of the connector of FIG. 5;

FIG. 7 is a bottom partial exploded view of the connector of FIG. 5;

FIG. 8 is a horizontal sectional view of the connector of FIG. 5;

FIG. 9 is a vertical sectional view of the connector of FIG. 5 and the circuit board of FIG. 4;

FIG. 10 is a perspective view of a connector terminal according to another exemplary embodiment; and

FIG. 11 is an exploded view of the connector terminal of FIG. 10.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

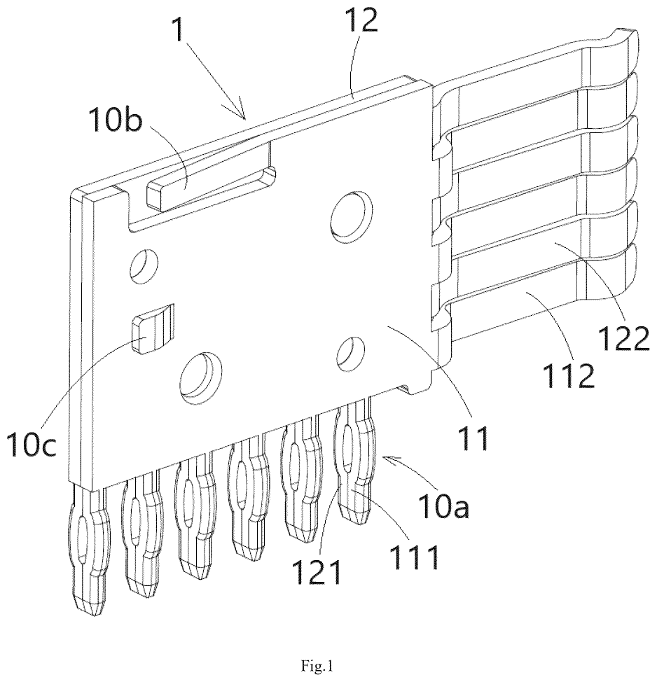

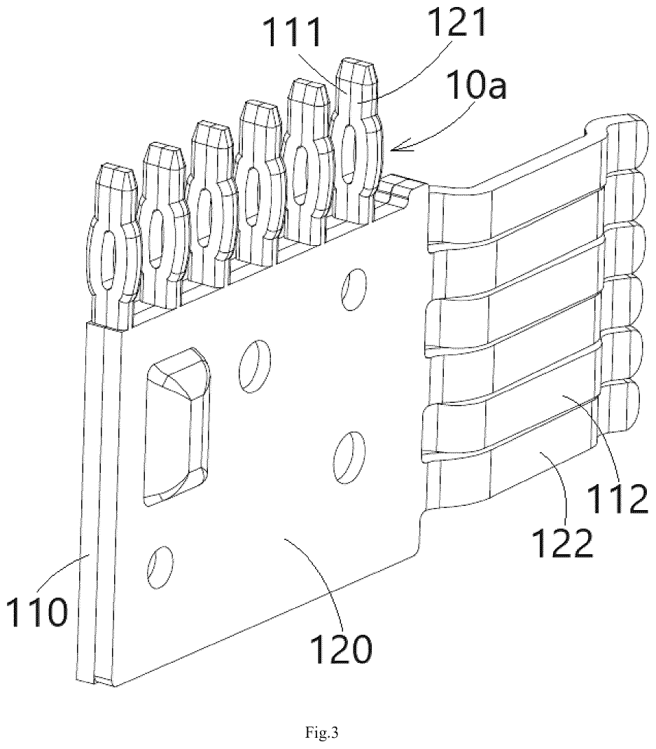

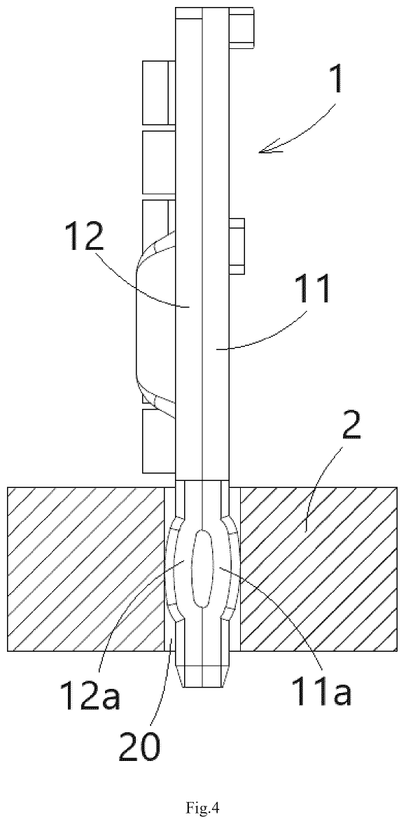

An exemplary embodiment of a connector terminal 1 will now be described with reference to FIGS. 1-9. As shown in FIGS. 1, 4, 6-7, and 9, the connector terminal 1 includes a first terminal 11 and a second terminal 12 combined together. The first terminal 11, as shown in FIG. 3, includes a first body 110 and a first pin 111. The first body 110 is in the form of a sheet, with upper and lower sides opposite in the vertical direction Z, and front and rear sides opposite in the longitudinal direction Y. The first pin 111 is connected to the lower side of the first body 110. The second terminal 12, as shown in FIG. 3, includes a second body 120 and a second pin 121. The second body 120 is in the form of a sheet, with upper and lower sides opposite in the vertical direction Z, and front and rear sides opposite in the longitudinal direction Y. The second pin 121 is connected to the lower side of the second body 120. The first body 110 and the second body 120 are stacked and fixed together, and the first pin 111 is combined with the corresponding second pin 121 to be suitable for simultaneous insertion into the same socket 20 formed in the circuit board 2.

As shown in FIGS. 1-3, 5, and 9, the first terminal 11 includes multiple first pins 111 arranged in a row along the longitudinal direction Y, and the second terminal 12 includes multiple second pins 121 arranged in a row along the longitudinal direction Y. Multiple first pins 111 correspond to multiple second pins 121, and each first pin 111 is combined with a corresponding second pin 121.

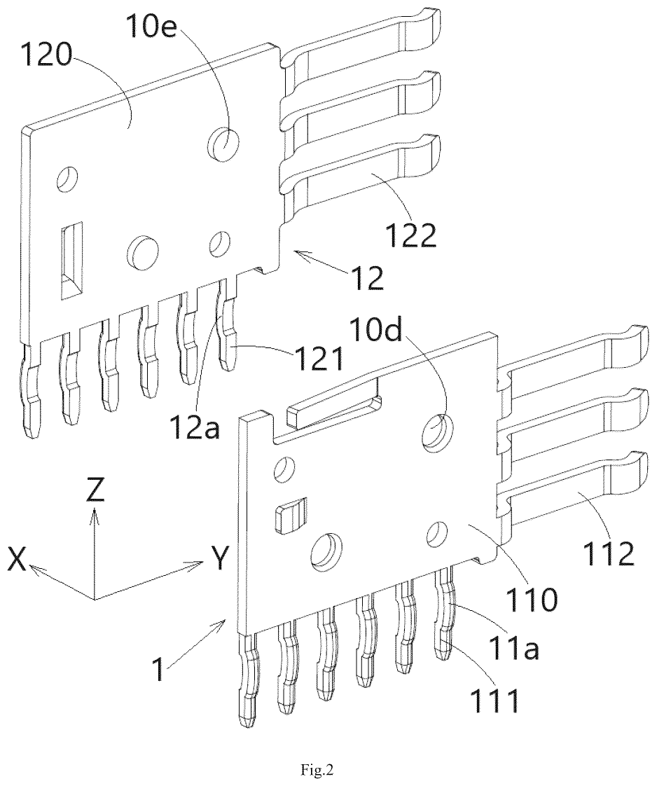

As shown in FIGS. 2, 4, and 9, a first arc-shaped portion 11a is formed on the first pin 111, and a second arc-shaped portion 12a is formed on the second pin 121. The first arc-shaped portion 11a on the first pin 111 and the second arc-shaped portion 12a on the corresponding second pin 121 are combined to form a fish eye 10a, as shown in FIGS. 1, 3, and 6, suitable for plugging into the same socket 20 in the circuit board 2. The fish eye 10a is suitable for interference fit with the socket 20 in the circuit board 2 to fix the first pin 111 and the second pin 121 combined together into the same socket 20 in the circuit board 2.

As shown in FIGS. 1, 3, and 6, the first arc-shaped portion 11a and the second arc-shaped portion 12a, which are combined to form the aforementioned fish eye 10a, arch in opposite directions in the thickness direction of the first body 110 and the second body 120, respectively.

The first body 110 and the second body 120 are riveted, clamped, or crimped together. As shown in FIG. 2, a riveting hole 10d is formed in one of the first body 110 and the second body 120, and a riveting protrusion 10e is formed on the other to be riveted into the riveting hole 10d, so that the first body 110 and the second body 120 are riveted together.

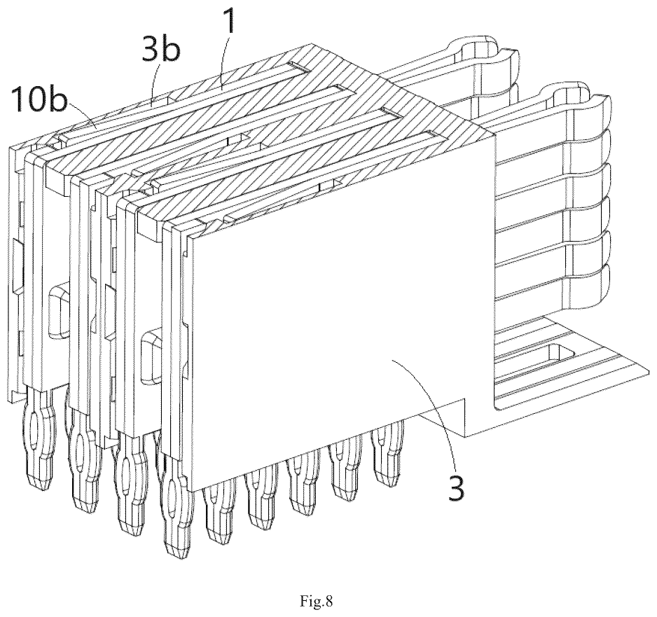

As shown in FIGS. 1, 6, and 8, a locking spring 10b is formed on the upper side of one of the first body 110 and the second body 120. The locking spring 10b is adapted to engage with a snap slot 3b, as shown in FIG. 8, in a connector housing 3 to lock the connector terminal 1 in the connector housing 3.

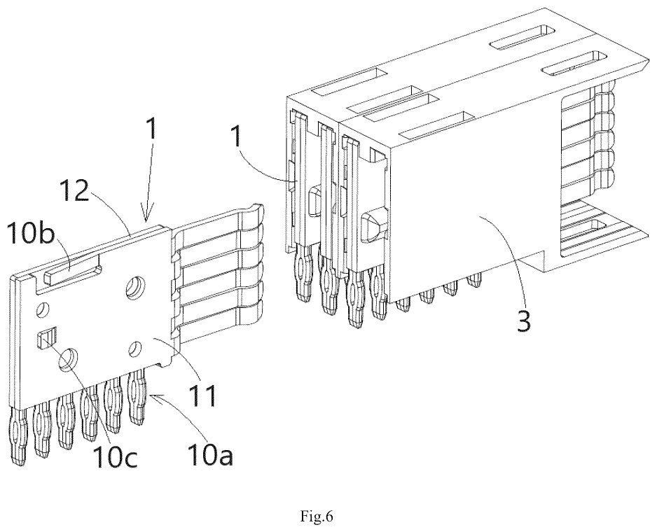

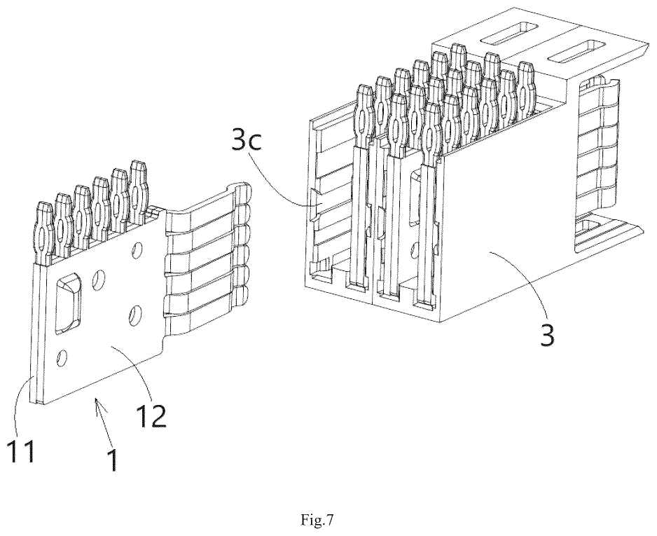

A guide protrusion 10c, as shown in FIGS. 1 and 6, is formed on the surface of one of the first body 110 and the second body 120, which is used to mate with a guide slot 3c, as shown in FIG. 7, in the connector housing 3 to guide the insertion of the connector terminal 1 into the connector housing 3. In the illustrated embodiment, the cross-section of the guide slot 3c and the guide protrusion 10c may be trapezoidal or dovetail shaped.

As shown in FIGS. 1-3, the first terminal 11 further includes multiple first contact spring arms 112, which are connected to the rear side of the first body 110 and extend a predetermined length along the longitudinal direction Y. The second terminal 12 also includes multiple second contact spring arms 122, as shown in FIGS. 1-3, which are connected to the rear side of the second body 120 and extend a predetermined length along the longitudinal direction Y. Multiple first contact spring arms 112 and multiple second contact spring arms 122 are alternately arranged in a row in the vertical direction Z, for electrical contact with the same mating terminal of a mating connector.

As shown in FIG. 2, each of the first terminal 11 and the second terminal 12 is an integral stamped part. This can improve manufacturing efficiency and production costs.

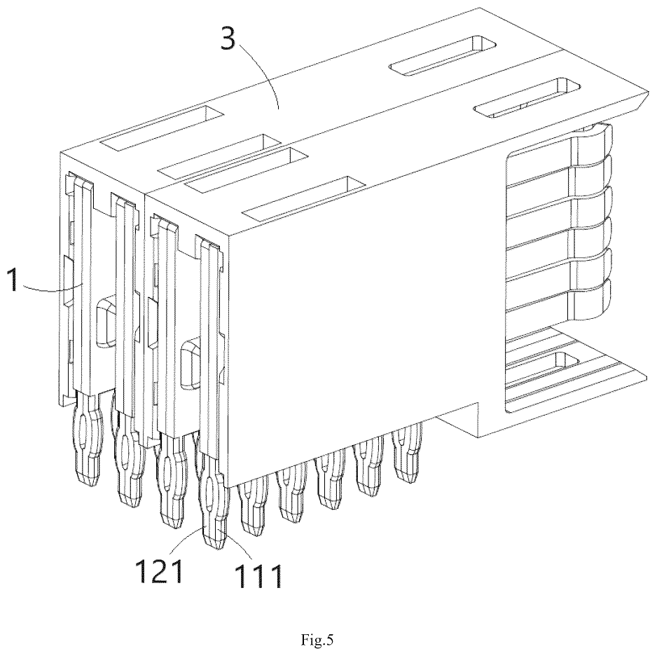

An exemplary embodiment of a connector will now be described with reference to FIGS. 1-9. The connector includes a connector housing 3, as shown in FIGS. 5-9, and the aforementioned connector terminal 1, as shown in FIGS. 1 and 4-8. The connector terminal 1 is inserted into the connector housing 3.

As shown in FIGS. 5-9, the connector includes multiple connector terminals 1, which are inserted into the connector housing 3 along the longitudinal direction Y and arranged in a row along the transverse direction X of the connector housing 3.

As shown in FIGS. 5-9, the connector housing 3 has a top and a bottom that are opposite in the vertical direction Z. The first pin 111 and the second pin 121 of the connector terminal 1 extend out from the bottom of the connector housing 3.

As shown in FIG. 8, a snap slot 3b is formed on the inner wall surface of the connector housing 3, which engages with the locking spring 10b of the connector terminal 1 to lock the connector terminal 1 in the connector housing 3.

As shown in FIG. 7, a guide slot 3 c extending along the longitudinal direction Y is formed on the inner wall surface of the connector housing 3. The guide slot 3c mates with the guide protrusion 10c on the connector terminal 1 to guide the connector terminal 1 to be inserted into the connector housing 3 along the longitudinal direction Y.

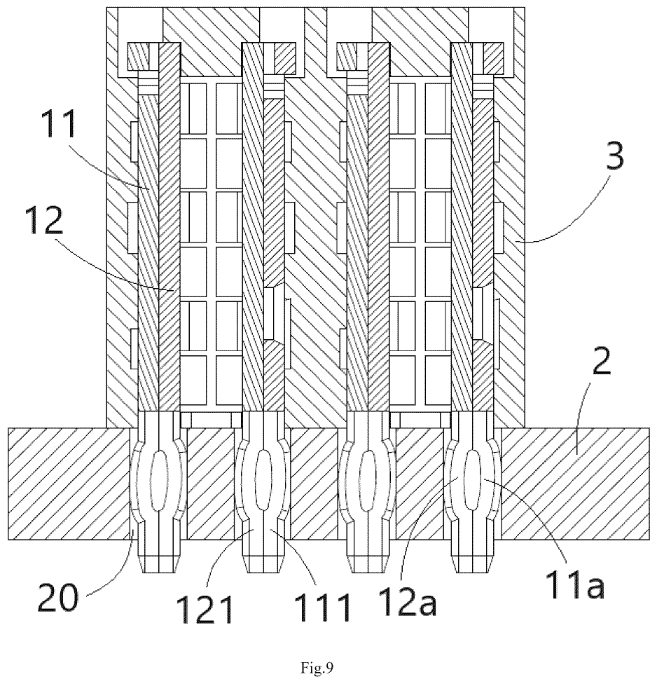

An exemplary embodiment of a connector assembly will now be described with reference to FIGS. 1-9. The connector assembly includes the aforementioned connector and a circuit board 2. As shown in FIG. 9, a socket 20 is formed in the circuit board 2. The connector housing 3 is installed on the circuit board 2, and the first pin 111 of the connector terminal 1 and the corresponding second pin 121 are combined together and plugged into the same socket 20 in the circuit board 2 to be electrically connected to the circuit board 2.

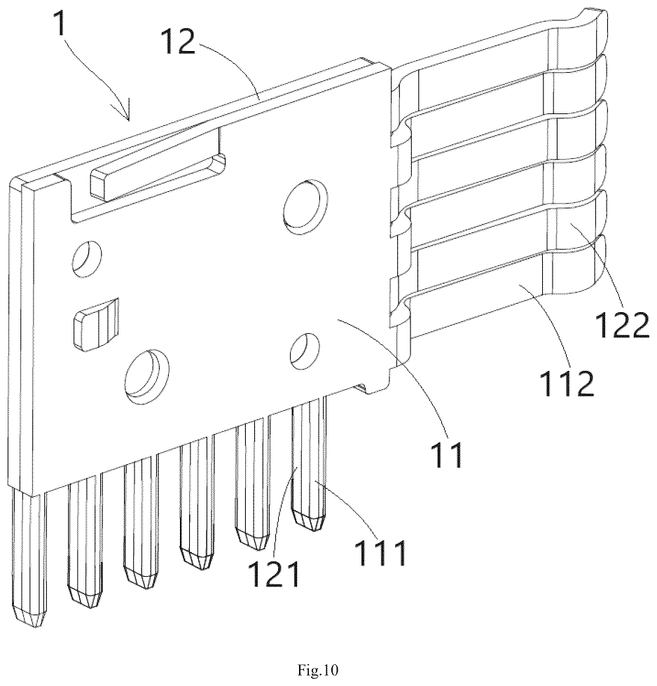

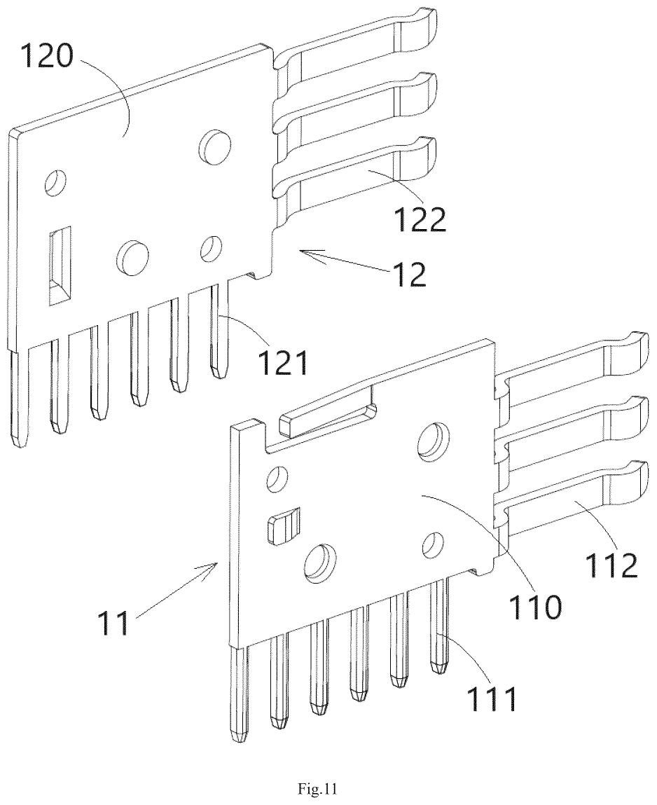

Another exemplary embodiment of a connector terminal 1 will now be described with reference to FIGS. 10-11. The only difference between the connector terminal 1 according to FIGS. 10-11 and the connector terminal 1 according to FIGS. 1-9 is the structure of the first pin 111 and the second pin 121.

As shown in FIG. 10, the first pin 111 and the second pin 121 are needle shaped vertically extending, and the first pin 111 and the corresponding second pin 121 are pressed against each other in the thickness direction of the first body 110 and the second body 120. The first pin 111 and the second pin 121 are combined together and plugged into the same socket 20 in the circuit board 2. Then, the first pin 111 and the second pin 121 can be soldered to the circuit board 2 to fix and electrically connect them to the circuit board 2.

Except for the aforementioned differences, the other features of connector terminal 1 according to FIGS. 10-11 are basically the same as those of connector terminal 1 according to FIGS. 1-9, which can be referred to as connector terminal 1 shown in FIGS. 1-9.

In the embodiments shown in FIGS. 1-11, the connector terminal 1 has a first contact spring arm 112 and a second contact spring arm 122. However, the present invention is not limited to the illustrated embodiments. For example, the connector terminal 1 may not have any contact spring arm, and the body of the connector terminal 1 may be fastened to a busbar by fasteners. Additionally, the structure and shape of the first pin 111 and the second pin 121 of connector terminal 1 are not limited to the illustrated embodiment and can be varied according to actual applications.

In the aforementioned exemplary embodiments according to the present invention, the first pin 111 of the first terminal 11 and the second pin 121 of the second terminal 12 of the connector are combined together for insertion into the same socket 20 in the circuit board 2. Therefore, the present invention can improve the current density of the circuit board 2, which is suitable for situations with limited space and expands the application range of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector terminal, comprising:
a first terminal including a first body in a form of a sheet and a first pin, the first body has an upper side and a lower side opposite in a vertical direction, and a front side and a rear side opposite in a longitudinal direction, the first pin is connected to the lower side of the first body; and
a second terminal including a second body in a form of a sheet and a second pin, the second body has an upper side and a lower side opposite in the vertical direction, and a front side and a rear side opposite in the longitudinal direction, the second pin is connected to the lower side of the second body, the first body and the second body are stacked and fixed together, the first pin is combined with the second pin for simultaneous insertion into a socket formed in a circuit board.

2. The connector terminal of claim 1, wherein the first terminal has a plurality of first pins arranged in a row in the longitudinal direction, and the second terminal has a plurality of second pins arranged in a row in the longitudinal direction, the plurality of first pins correspond to the plurality of second pins, each first pin is combined with one second pin.

3. The connector terminal of claim 1, wherein the first pin and the second pin extend vertically in a needle shape, each first pin and a corresponding second pin are pressed against each other in a thickness direction of the first body and the second body.

4. The connector terminal of claim 1, wherein a first arc-shaped portion is formed on the first pin, a second arc-shaped portion is formed on the second pin, and the circuit board has a plurality of sockets, the first arc-shaped portion on each first pin and the second arc-shaped portion on a corresponding second pin are combined to form a fish eye, each fish eye is plugged into one socket in the circuit board.

5. The connector terminal of claim 4, wherein each fish eye is interference fit with one socket in the circuit board to fix each first pin and each second pin combined together into one socket in the circuit board.

6. The connector terminal of claim 4, wherein each first arc-shaped portion and each second arc-shaped portion combined into the fish eye respectively arch in opposite directions in a thickness direction of the first body and the second body.

7. The connector terminal of claim 1, wherein the first body and the second body are riveted, clamped, or crimped together.

8. The connector terminal of claim 1, wherein a riveting hole is formed in one of the first body and the second body, and a riveting protrusion is formed on an other of the first body and the second body, the riveting protrusion is riveted into the riveting hole such that the first body and the second body are riveted together.

9. The connector terminal of claim 1, wherein a locking spring is formed on the upper side of one of the first body and the second body, the locking spring engages with a snap slot in a connector housing to lock the connector terminal in the connector housing.

10. The connector terminal of claim 1, wherein a guide protrusion is formed on a surface of one of the first body and the second body, the guide protrusion mates with a guide slot in a connector housing to guide insertion of the connector terminal into the connector housing.

11. The connector terminal of claim 1, wherein the first terminal has a plurality of first contact spring arms connected to the rear side of the first body and extending a predetermined length along the longitudinal direction.

12. The connector terminal of claim 11, wherein the second terminal has a plurality of second contact spring arms connected to the rear side of the second body and extending a predetermined length along the longitudinal direction.

13. The connector terminal of claim 12, wherein the plurality of first contact spring arms and the plurality of second contact spring arms are alternately arranged in a row in the vertical direction for electrical contact with a same mating terminal.

14. The connector terminal of claim 1, wherein each of the first terminal and the second terminal is an integral stamped part.

15. A connector, comprising:
a connector housing; and
a connector terminal including a first terminal and a second terminal, the first terminal including a first body in a form of a sheet and a first pin, the first body has an upper side and a lower side opposite in a vertical direction, and a front side and a rear side opposite in a longitudinal direction, the first pin is connected to the lower side of the first body, and the second terminal including a second body in a form of a sheet and a second pin, the second body has an upper side and a lower side opposite in the vertical direction, and a front side and a rear side opposite in the longitudinal direction, the second pin is connected to the lower side of the second body, the first body and the second body are stacked and fixed together, the first pin is combined with the second pin for simultaneous insertion into a socket formed in a circuit board, the connector terminal is inserted into the connector housing.

16. The connector of claim 15, wherein the connector has a plurality of connector terminals each inserted into the connector housing along the longitudinal direction and arranged in a row in a transverse direction of the connector housing.

17. The connector of claim 16, wherein the connector housing has a top and a bottom that are opposite in the vertical direction, the first pin and the second pin of the connector terminal extend from the bottom of the connector housing.

18. The connector of claim 16, wherein a snap slot is formed on an inner wall surface of the connector housing, the snap slot is engaged with a locking spring of the connector terminal to lock the connector terminal in the connector housing.

19. The connector of claim 16, wherein a guide slot extending along the longitudinal direction is formed on an inner wall surface of the connector housing, the guide slot is mated with a guide protrusion on the connector terminal to guide insertion of the connector terminal into the connector housing along the longitudinal direction.

20. A connector assembly, comprising:
a connector including a connector housing and a connector terminal, the connector terminal including a first terminal and a second terminal, the first terminal including a first body in a form of a sheet and a first pin, the first body has an upper side and a lower side opposite in a vertical direction, and a front side and a rear side opposite in a longitudinal direction, the first pin is connected to the lower side of the first body, and the second terminal including a second body in a form of a sheet and a second pin, the second body has an upper side and a lower side opposite in the vertical direction, and a front side and a rear side opposite in the longitudinal direction, the second pin is connected to the lower side of the second body, the first body and the second body are stacked and fixed together, the connector terminal is inserted into the connector housing; and
a circuit board formed with a socket, the connector housing is installed on the circuit board, the first pin is combined with the second pin for simultaneous insertion into the socket such that the first pin and the second pin are electrically connected to the circuit board.
